(19) United States
(12) Patent Application Publication
(10) Pub. No.: US 2005/0164154 A1
(43) Pub. Date: Jul. 28, 2005

(54) Demand initiated customized e-learning system

(75) Inventor: Neal Solomon, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Geodesic Dynamics, Piedmont, CA (US)

(21) Appl. No.: 11/040,920

(22) Filed: Jan. 21, 2005

Related U.S. Application Data
(60) Provisional application No. 60/538,709, filed on Jan. 23, 2004.

(51) Int. Cl. G09B 3/00

(52) U.S. Cl. 434/350

(57) ABSTRACT

A system, methods and apparatus are described involving modular customized e-learning components. After an individual requests an e-learning process, databases are customized for him or her, thereby implementing just-in-time learning. The learner generates questions by using problem finding approaches and may use a personal learning agent. Collaboration between individuals is performed. In addition, a method is presented for conducting distributed classes both with and without (a teacher's) mediation. Part of the system involves a method featuring a dialectical learning process for problem solving. There is an automatic method to assess individual abilities.

### CROSS-REFERENCES TO RELATED APPLICATIONS

The present application claims the benefit of priority under 35 U.S.C. 119 from U.S. Provisional Patent Application Ser. No. 60/538,709, filed on Jan. 23, 2004, the disclosures of which are hereby incorporated by reference in their entirety for all purposes.

### BACKGROUND OF THE INVENTION

Increasingly, education, and in particular, higher education, is the determining factor for individual success in industrial countries. However, because large groups of individuals are excluded from educational opportunities, there is a great need to develop alternative models for acquiring knowledge. The advent of the Web brings a new category of technologies to the fields of knowledge delivery and pedagogical methodology. With the interactive capabilities of the Web come opportunities to design customized education models that are non-distance sensitive and collaborative. In fact, the dominant centralized model of the university of the last millennia may be jeopardized by the development of the new educational models that these technologies bring.

The traditional educational institution is didactic and pedantic, with an authoritative teacher in a centralized classroom that supplies information at a predetermined pace in a factory-style, mass production setting. College texts are canned compilations of original thinking. Because it is conceived as the unilateral providing of canonical knowledge, traditional education is rarely interactive. Except at the very top of the education hierarchy, the learning process is neither creative nor customized.

Unfortunately, the main model of e-learning simply ports this dysfunctional education system over to the Internet. A paradigm example is the MIT teaching model which simply places its edified scientific curricula online. The same teachers pass the same information on to a broader audience using similar lecture methods. The factory is larger than a lecture hall but it is still the same production process. The one advantage of this online education model is that it is time-shifted; students can take courses at a time of their choosing rather than show up to a centralized classroom. This old model of e-learning is linear and as stale as the education system from which it derives. Although there may be some limited areas of knowledge, most notably the physical sciences, which are conducive to this type of learning process, this e-learning process is restrictive. Canned knowledge and the factory method of edification employed to imbue it are not effective beyond narrow specialized fields of knowledge in the short run. Any model that merely emulates centralized traditional education models is sure to be dysfunctional, problematic, incomplete and uncompetitive.

At the same time, because education and knowledge are too narrowly interpreted, employers perceive there to be a severe shortage of well-trained individuals to hire. Universities, post-graduate education, corporate training programs and general life of learning require more, and better, learning methods. There is a great need to develop learning approaches that go beyond the didactic teaching models. Such a demand for new learning methods involves the need to develop novel models for optimal personal achievement. These new approaches need to be individual centered rather than bureaucratic, interactive rather than linear and centralized, customized rather than mass produced, and creative rather than unimaginative.

Although education is essential to the health of democratic institutions, and critical to success, most people sleepwalk through school, career and life. New methods that facilitate the acquisition of personal knowledge need to be posited. Further, such a system should be accessible to tens of millions of individuals who will doubtless learn at different rates and who will prefer the flexibility of demand-based learning methods. In fact, the use of such novel methods can accelerate individual knowledge acquisition and development so as to empower large groups to achieve greater goals. Because the world and our understanding of it changes, knowledge evolves. Therefore, new learning processes need to accommodate the adaptive aspects of this evolution. Existing models of teaching cannot effectively keep up with these changes.

The present system draws from research in psychology and education which establishes that individuals differ and therefore learn differently. If we are each endowed with different skills, then we will benefit from different learning methods. The education literature on “multiple intelligences” corroborates this view, advocating a number of kinds of knowledge beyond merely the analytical type on which education is widely based. Most of these areas of knowledge correspond to individuals' natural cognitive differences. As our knowledge about the physiology and anatomy of the brain increases, we increasingly realize the need to tailor education to each individual's preferences and abilities. This way of thinking conforms to John Dewey's view that individuals need to be educated in the context of their unique differences rather than within a centralized bureaucratic factory model that benefits teachers at the expense of students. This is the first education and e-learning model that embraces the literature of epistemology, phenomenology and pragmatism dating from Plato, Kant and Hegel to Husserl and Dewey and that puts the individual at its center. The new generation of technologies is what renders the individual-centered model of knowledge and education realizable. No pre-existing model has come close to offering the combination of benefits that the present system provides.

Whereas numerous advances on small parts of computer systems have been introduced, relatively little research has addressed the management, control, automation and synthesis of complex aspects of dynamic interactive customized e-learning systems. The present system is intended to fill this important gap in the research literature.

### BRIEF SUMMARY OF THE INVENTION

Embodiments of the present invention provide a system that optimizes learning processes for individuals. According to one aspect of the invention, a customized demand-initiated e-learning system architecture having a plurality of system layers interconnected to one another is provided. A first layer includes a hardware and software system including microprocessors and pushed databases for just-in-time (JIT) teaching. A second layer includes problem finding and question generation. A third layer includes personal learning agents (PLAs). A fourth layer includes collaboration using intelligent mobile software agents (IMSAs). A fifth layer includes distributed interactive classes with mediation. A sixth layer includes distributed interactive classes without mediation. A seventh layer includes dialectical learning processes for problem solving in a distributed interactive system. An eighth layer includes a mechanism for the assessment of individual abilities.

### BRIEF DESCRIPTION OF THE DRAWINGS

FIG. 1 is a diagram showing the levels of a modular e-learning system

FIG. 2 is a schematic diagram of a system overview of a custom demand-initiated e-learning apparatus

FIG. 3 is a schematic diagram of an abstract of the e-learning system

FIG. 4 is a list of a typology of learning categories

FIG. 5 is a schematic diagram of a pushed database for e-learning.

FIG. 6 is a flow chart showing the operation of a customized database.

FIG. 7 is a flow chart showing searches in real time of the latest topics.

FIG. 8 is a flow chart showing an open search process.

FIG. 9 is a flow chart describing a question generation process.

FIG. 10 is a flow chart showing a collaborative filtering process for e-learning.

FIG. 11 is a diagram illustrating the personal learning agent (PLA) functions.

FIG. 12 is a flow chart showing the PLA process.

FIG. 13 is a flow chart showing the PLA search process.

FIG. 14 is a flow chart showing the PLA research process.

FIG. 15 is a flow chart showing the PLA analysis process.

FIG. 16 is a schematic diagram illustrating cooperating and competing teams of students over time in a distributed interactive system.

FIG. 17 is a schematic diagram showing a multi-phasal student interaction in a distributed system.

FIG. 18 is a schematic diagram describing asymmetric interaction between students in a mediator-driven learning system.

FIG. 19 is a schematic diagram showing a student as thought leader reviewing research directly and sharing research with other students.

FIG. 20 is a schematic diagram showing two sets of students collaborating and subsets of these groups interacting with a mediator.

FIG. 21 is a schematic diagram showing a multi-phasal process of students aggregating by common interest topic into new groups.

FIG. 22 is a flow chart of a centralized mediator driven distributed interactive class.

FIG. 23 is a schematic diagram showing twelve overlapping sets of similarly interested students.

FIG. 24 is a schematic diagram of a multi-phasal process in which a student interacts with various students on different topics.

FIG. 25 is a schematic diagram showing a distributed interactive learning system in which various students collaborate on different research projects.

FIG. 26 is a flow chart showing a process of disintermediated interaction among students in a distributed learning system.

FIG. 27 is a schematic diagram illustrating a multi-phasal dialectical process of interaction between two parties.

FIG. 28 is a schematic diagram showing an asymmetric distributed argumentation system.

FIG. 29 is a flow chart showing a problem solving process.

FIG. 30 is a flow chart showing a category schema process.

FIG. 31 is a flow chart showing the synthesis of inductive and deduction reasoning methods.

FIG. 32 is a flow chart showing a Bayesian approach to problem solving.

FIG. 33 is a flow chart showing the application of various methods to problem solving at key times.

FIG. 34 is a schematic diagram of an epistemological circle.

FIG. 35 is a flow chart of a typology of learning profiles.

FIG. 36 is a flow chart describing a time-sensitive testing process.

FIG. 37 is a flow chart showing a customized dynamic testing process.

FIG. 38 is a tree diagram of contingent questions in a dynamic interactive examination.

### DETAILED DESCRIPTION OF THE INVENTION

Demand-initiated distance learning involves location-independent and time-independent e-learning in which an individual's program is flexible and customized by the use of interactive technologies. Once an individual requests a program from a list of choices, the individual is provided with a focused and personalized program of study. A characteristic is that the individual initiates the learning process which is then tailored to him or her.

The demand-initiated customized interactive e-learning system utilizes several modular integrated components: (1) Pushed Databases for Just-in-Time Learning; (2) Question Generation for Problem Finding; (3) Personal Learning Agents; (4) Collaboration as Competition and Cooperation (5) Distributed Classes Without Mediation; (6) Distributed Classes With Mediation; (7) Dialectical Learning Process for Problem Solving and (8) Assessment of Individual Abilities. These components are described as follows:

(1) Pushed Databases for Just-in-Time Learning. Once a customized program of study has been designed, a range of information is organized for the individual learner. This customization results from information being pushed from a broad range of databases into a specific database that accommodates the unique needs of the individual. This approach facilitates Just-in-Time learning, a crucial component of the learning process. Each unique and timely database reflects the needs of the learner.

These time-sensitive databases may be tiered in such a way that access is contingent on achievement. After core requirements are satisfied, a narrowing process continually refocuses content for optimization of the learning process. Testing may be performed in order to assess knowledge acquisition. Further, distinct modules may provide layers of data in which to satisfy requirements in a succession of knowledge thresholds.

(2) Question Generation for Problem-Finding. Asking the right questions is a fundamental aspect of knowledge acquisition. Yet, how does one know what question to ask if one does not have knowledge? This key epistemological question goes back to Plato. One solution to this problem is the construction of complex intelligent expert system that asks questions on specific topics. A novel query generation approach can be developed for adaptive questioning whereby generated questions may lead to additional questions. In response to requests for knowledge, intelligent agents generate further questions that are ranked by user-adjustable factors. A search agent filters the best datasets obtainable from databases and structures these datasets into an organized format. With this approach, a user can access the contents of texts, including linked encyclopedias; the range of the search successively narrows as the individual continually refocuses. Since narrow queries generate limited information and broad queries generate a surplus of information, information requests must become personalized. Brainstorms are promoted and optimized in real time via this method so that a cascade of information recovery is made possible. The key functions here are the identifying of problems out of a complex set of data and the realizing of patterns that lead to the organization of ideas and the development of knowledge. In effect, this model provides a novel approach to performing research.

(3) Personal Learning Agents. A personal learning agent (PLA) is an intelligent software agent that performs several functions intended to assist an individual in the learning process: research, new idea generation through brainstorming, organization of thought, structuring of work product. This software program evolves and adapts to the needs of the individual; in effect, it learns about the individual and customizes itself to fit the needs of the individual. The personal learning agent is programmed with advanced expert system procedures but uses inductive inference approaches to test various methods. The PLA learns by using genetic programming, Bayesian reasoning and other AI techniques that optimize automated learning processes.

The PLA interacts with an individual to perform research (including data collection, categorization of material, etc.), assist in the analysis and interpretation of research material, develop and organize research notes from original and secondary readings, interact with the individual in order to prepare an outline of a work product and organize, develop and draft a work product. PLAs may become a key component in the development of customized interactive knowledge acquisition.

(4) Collaboration. Since the development of knowledge is often a shared experience, collaboration between individuals is important. New interactive technologies can facilitate real-time collaboration of individuals. By collaborating within knowledge-specific communities, individuals can communicate with like-minded others and engage in dialogues that lead to further knowledge development. This socialization process leads to team development in which a temporary leader asks or answers questions for the group. Sharing projects within teams is another way collaboration yields valuable knowledge. Generally, collaboration occurs within a cooperative environment. However, collaboration may also occur within an environment of teamwork that involves asymmetric competition between individuals, and with it, the impetus to push beyond one's own abilities. All of this can occur in a disintermediated and decentralized environment.

(5) Distributed Classes Without Mediation. It is not a far step to go from informal collaboration to distributed classrooms without mediation. In this development, a group meeting occurs at a scheduled time, but across distances; participants join in real time on-line using interactive technologies. A class can be organized to pursue a specific subject and can work together to study common material. Because this simple form of a class is unmediated, any individual can initiate a question or answer; however, individuals need a minimum threshold of qualification in order to pursue knowledge in a specific category. Each class is structured precisely, according to specific categories and levels of knowledge. Individuals within each class may communicate by using instant messaging. Such unmediated distributed classes are self-organized according to specific rules.

(6) Distributed Classes With Mediation. The role of the teacher as mediator distinguishes a mediated distributed class from an unmediated one. Reputations of teachers are weighted with individual student and research feedback. Specific teacher functions are deconstructed, and some of these may be automated (such as e-mail follow-ups to questions). These functions include lecturing, guidance, reviewing work, tutoring or mentoring, and leading a class.

There are distinct differences between a centralized class meeting at a specific time and place, and a decentralized and distributed class, which may be mediated by a teacher or thought leader. A thought leader has experience in a specific field and is responsible for acquiring knowledge and researching knowledge related to this field. It is the responsibility of a thought leader to initiate the activities of a distributed class by establishing a learning plan in a specific category and level of knowledge. Much of the mediation process is accomplished by carefully scheduling and prioritizing the timing of presentation of learned material. When combined with individual customized learning programs, this mediated classroom provides a key supplemental method within the e-learning model.

(7) Dialectical Learning Process and Problem Solving. In most oepistemological inquiries, the dialectical process of learning is central. This method typically begins with a naive position, identifies and develops its opposite, develops an interaction between these two approaches and, finally, develops a resolution or new position. These are the distinct phases of the dialectical process. In the context of group learning, the dialectical method involves different individuals with different levels of insight or understanding, thereby exemplifying a multilateral epistemological model.

The dialectic method is a useful part of interactive customized learning models. An active learning process allows a field to be understood in phases, leading to the culmination of a deeper understanding of the subject. The dialectical method of learning teaches individuals how to think in a critical, creative, constructive, efficient and balanced way. In addition, this approach provides for the constant reorganization of knowledge. In this sense, our model represents a phenomenological approach to demand-based distance learning because it uses dialectical methods which are optimized for individual learning.

Dialectical methods of learning are of maximum benefit in contexts of constantly increasing levels of knowledge or where competence and promotion need to be determined.

Finally, dialectical approaches to learning allow the combination of learning methods because experience indicates what set of methods to apply to specific subjects at different times. In this sense, dialectics are synthetic and meta-learning tools for knowledge acquisition.

The use of dialectics helps in problem solving processes. In the context of customized demand-initiated e-learning programs that use interactive technologies to go beyond the traditional educational model of distance learning, dialectics provide methods to solve problems that are ideally suited to individualized learning. For instance, once a problem is identified, solution scenarios are generated via dialectical approaches and a learning strategy is commenced. This problem based model of learning, hence, optimizes and guides healthy brainstorms that are the foundation of both knowledge acquisition and creativity.

Dialectical approaches are used in legal, philosophical and social argumentation to build theories of knowledge. Dialectics as applied to customized interactive demand-initiated education provide for the development of original thinking skills.

(8) Assessment of Abilities. It is helpful to develop a method to assess an individual's abilities throughout the learning process. Skill assessment is useful, whether the individual develops rapidly or slowly. The advantage of our system is that it allows a variable rate of development. It is important to develop a fair assessment of each individual's capabilities and interests in order to ask “what do you know?” at various stages of development and “what do you need to learn?” (or “what do you not know but need to know?”). These assessments may not be uniform across the population. The distinctive attribute of the present system is that it develops multiple intelligences beyond any given individual's analytical abilities.

An initial assessment enables individuals to generate and refine optimal learning plans for them. With the present system, self-learning is optimized in such a way as to be competitive with traditional education and with traditional distance learning models.

Problems That the System Solves

The present system is applicable to myriad fields of knowledge, including: Philosophy, History, Literature, Psychology, the Arts, Sociology, Political Science, Economics, Education, Anthropology, Law, Business, Religion, Physics, Chemistry, Biology, Mathematics, Engineering (electrical, mechanical, aeronautical, chemical, biological, computational, information, etc.), and Languages as well as corporate training.

There are a number of problems that the system solves. The problems can be delineated via the following questions: How can a learning model develop critical thinking, creativity and good judgment? How can such a system go beyond mere memorization of facts and the limits of super-specialization and quantitative priority knowledge? How can ideas and time be optimally organized and managed to facilitate knowledge development? How can writing and editing skills be learned? How can high standards be maintained in such an education system?

Advantages of the System

The present system has numerous advantages. Its aspects are active as well as interactive. Being demand-initiated, the system provides maximum benefit to individuals. It also provides an efficient approach to high quality education, thereby providing cost cutting opportunities within the education marketplace. This efficient model can thereby bring quality education to millions of individuals who were previously excluded.

The present system involves computer interactions that allow for customization of education functions. The use of PLAs accelerates search, research and analytical functions. The use pushed databases allow information to be sent to individuals just in time so as to satisfy time sensitive learning situations. The use of interactive technologies allows various configurations of centralization and decentralization so as to optimize the learning process. Dialectical methods are automated in order to accelerate the learning process. These technological processes, taken together, allow an individual-centered learning system to advance knowledge in the shortest possible time.

The present system is more than merely the delivery of content. This system also provides a critical customization component to e-learning. Such customized knowledge acquisition provides maximum flexibility in a context of variable learning rates.

The novel learning method of the present system employs multiple interdependent modules for the search, acquisition, collaboration and assessment of knowledge.

References of the remaining portions of the specification, including the drawings and claims, will realize other features and advantages of the present invention. Further features and advantages of the present invention, as well as the structure and operation of various embodiments of the invention, are described in detail below with respect to accompanying drawings; like reference numbers indicate identical or functionally similar elements. Since the present invention has numerous embodiments, the intent herein is not to restrict the invention to a single embodiment.

The system and methods incorporated in the present invention are implemented by using software program code applied to networks of computers. Specifically, the present invention represents a customizable adaptive distributed computer system that includes a multi-agent system (MAS). The main embodiment of the distributed computer system is implemented with complex databases.

A function of the system is to optimize learning processes for individuals. The invention presents a modular interactive distributed computer system for the operation of customized learning processes. These processes include just-in-time (JIT) teaching, problem finding and question generation, personal learning agent interaction, collaboration, distributed interactive classes with and without mediation in real time, dialectical learning approaches and dynamic interactive abilities assessments.

The detailed description of the drawings is divided into several parts that explain: (1) the overall system for linking customized learning processes; (2) Pushed Databases for JIT Learning; (3) Personal Learning Agents; (4) Collaboration as Competition and Cooperation; (5) Distributed Classes Without Mediation; (6) Distributed Classes With Mediation; (7) Dialectical Learning Processes for Problem Solving and (8) Dynamic Assessment of Individual Abilities.

General Architecture and Dynamics

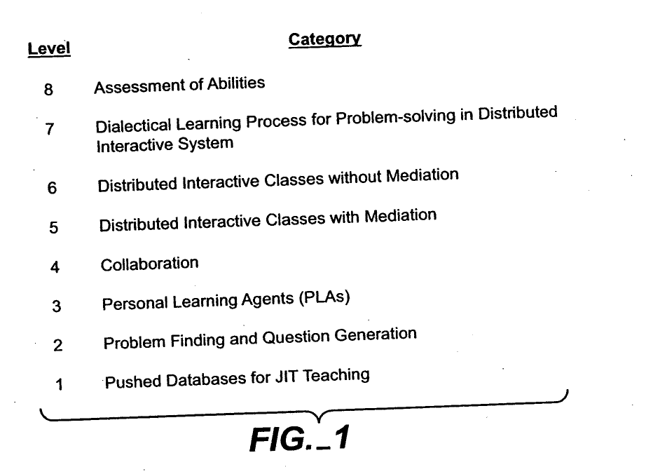

FIG. 1 illustrates the layers of the demand-initiated customized e-learning system architecture. The first level shows the databases for JIT teaching. These databases have content pushed to them continuously. Through a human-computer interface, the databases are queried on demand by individuals.

On the second level, problems are identified and questions are generated. Since it is important to learn to ask the right question(s) before a query generation process is initiated, the problem-finding methods are particularly valuable.

Level three features personal learning agents (PLAs). PLAs are automated software agents that perform specific functions such as complex search processes, research processes and analytic processes. In effect, these software agents emulate a highly effective secretary and serve to accelerate and to focus the learning experience.

On level four, collaboration of individuals is performed. Collaboration comes in the form of cooperation, competition or combinations of these main models. Collaboration processes are not necessarily performed in real time or with direct interactivity but may occur asymmetrically.

Level five features distributed interactive classes with mediation. This process of establishing distributed interactive classes emulates the functioning of a typical classroom process with a teacher leading the real-time distributed session.

Level six features distributed interactive classes without mediation. Without the teacher pedagogue, the students cooperate in order to form a study group to learn about various subjects directly.

Level seven features the dialectical learning process for problem-solving in the distributed interactive system. Several main dialectical learning processes are delineated in which deeper learning of many subjects is accelerated.

Finally, on the eighth level, there is a dynamic assessment of abilities. In this function, an individual's knowledge of a subject is examined interactively contingent on prior answers to questions. Interactivity optimizes the direction of the line of questioning. This model is more efficient and fairer than traditional models.

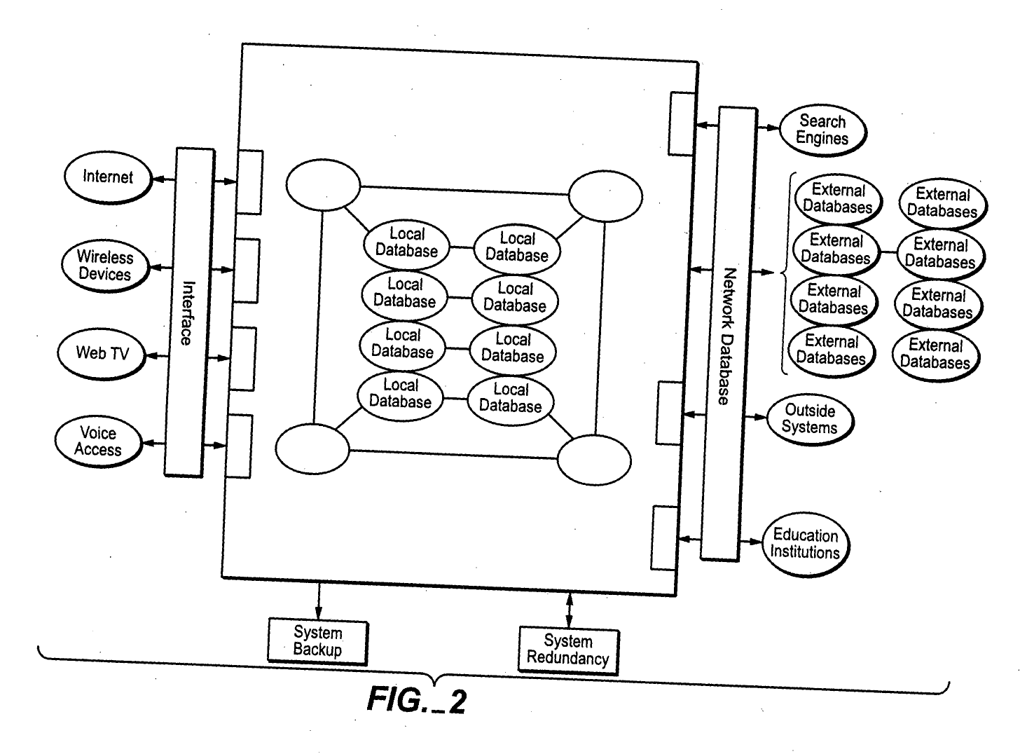

Referring generally to FIG. 2, the system consists of the following components:
a) Multiple interlinked servers with multiple processors; network interfaces (e.g. wired Internet, wireless data devices, Web TV and voice access) including links to individual computer nodes and teacher computer nodes and one or more computer memories; distributed storage area networks, and provisions for system and operational redundancies, reliability and backup.
b) Software to operate the system, including intelligent mobile software agents such as personal learning agents that provide intelligent analytical recommendations based upon various collaborative filtering techniques, to maintain student profiles, and to search for and collect specific data. The software system includes not only local databases but also outside databases of individual users and educational institutions. The databases are accessed with search engines.
c) Firewalls and/or proxy servers, to maintain high-level integrity of the data, including student and teacher information.

It is assumed that users will access the system via the World Wide Web or a local area network. However, the system is accessible via other well known electronic communication networks, including a cable television network, satellite system, and wireless communications systems.

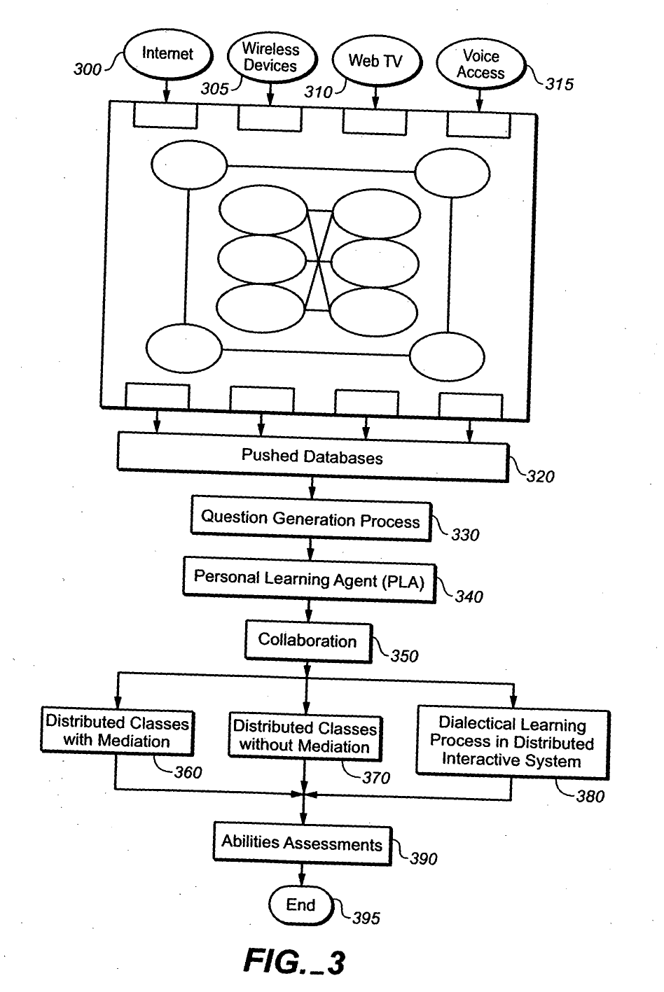

FIG. 3 is an abstract of the overall system. After accessing the main system by way of the Internet, wireless devices, Web television or voice access, individuals have access to the pushed databases (320), question-generation process (330), PLA (340) and collaboration (350) approaches. Subsequent to the collaboration model, individuals will have the option to interact with distributed classes with mediation (360), distributed classes without mediation (370) and dialectical learning approaches. Abilities are then assessed (390).

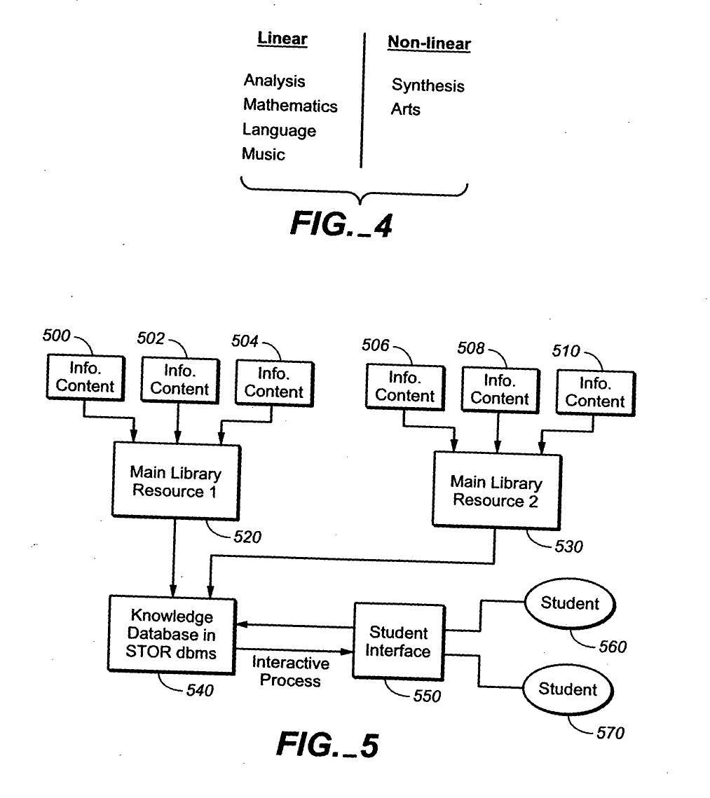

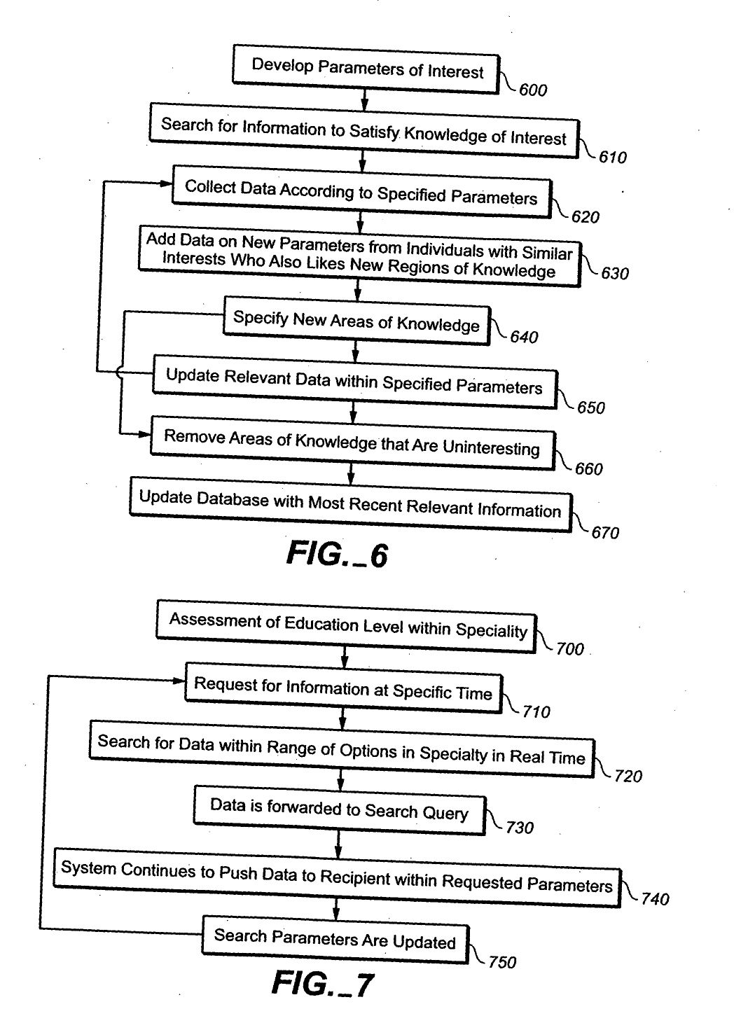

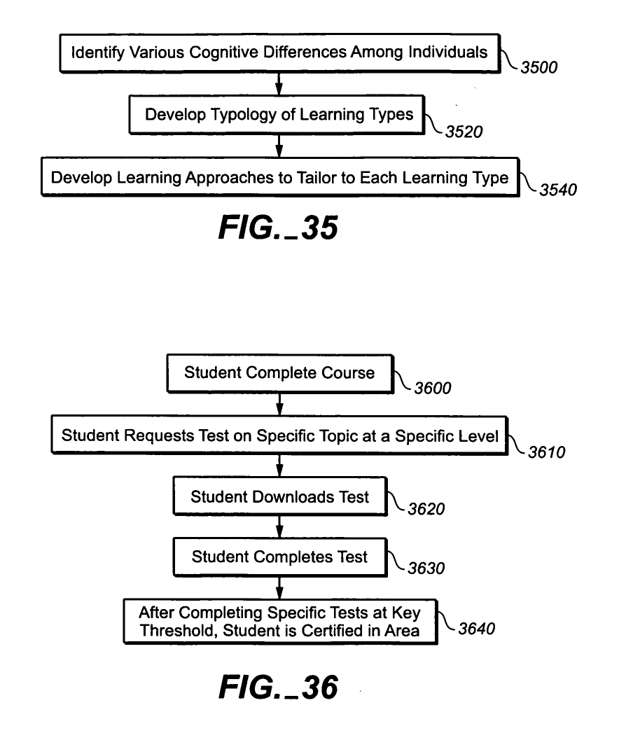

In FIG. 4 a table lists a typology of learning categories. These main categories are divided into linear and non-linear qualities that mirror individuals' cognitive capacities. The linear column lists analysis, mathematics, language and music. The non-linear column lists synthesis (i.e., the combination of ideas) and the arts. Refer to FIG. 35 below for a description of a method of tailoring learning approaches to these learning categories. There may be other learning category schemas as well.

FIG. 5 shows the pushed database system. Individual information content categories are continuously input into the main library resources. Information content (500, 502 and 504) is input into the main library resource 1 (520) while another set of information content (506, 508, and 510) is input into the main library resource 2 (530).

The main library resources are input into a knowledge database in a spatio-temporal object relational (STOR) database management system (dbms) (540). These STOR databases are distributed at various locations and are connected by a wide area network (WAN). STOR databases represent a contemporary model for data storage because they merge qualities of the object relational database model with robust spatio-temporal data sets. Spatio-temporal data sets most fully embrace the four dimensional data sets in which real-world objects are structured and operate. In other embodiments of the invention, relational databases, object databases and object relational databases will be employed.

Once the main library resources input data into the STOR dbms, students (560 and 570) access the system at the human-computer interface (550).

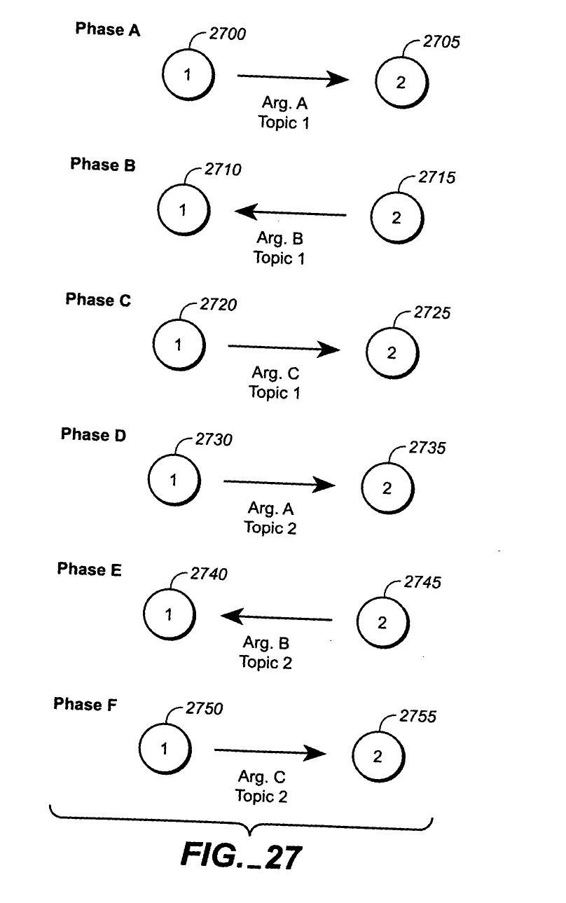

FIG. 5 describes the operation of a customized database. After the system initially develops an individual's parameters of interest (600), that user searches for information (610) and collects data according to the specified parameters (620). However, in order to expand the range of knowledge about a subject, an individual's knowledge parameters need to be supplemented. Consequently, data is added from individuals with similar interests (630) to expand parameters. New knowledge areas are specified (640), and relevant data is updated within specified parameters (650). At this juncture, either new data need to be collected according to the newly specified parameters (620) or areas of knowledge that are tangential are pruned (650) to allow the student to focus on a specific region of knowledge. The database is then updated with the most recent relevant information (670). Compare FIGS. 27 to 34 for a discussion of dialectical processes in the interactive distributed computer system.

Searches of the latest topics in real time are described in FIG. 7. The process begins with an assessment of education level within a specialty (700). A request for information is then made at a specific time (710), and the search begins for data within the range of options in a specialty (720). Data is then forwarded to the search query (730), and the system continues to push data to the recipient within the requested parameters (740). The search parameters are updated (750), which leads back to a request for time-sensitive information (710). In another embodiment of the invention, other search methods may be used to obtain information.

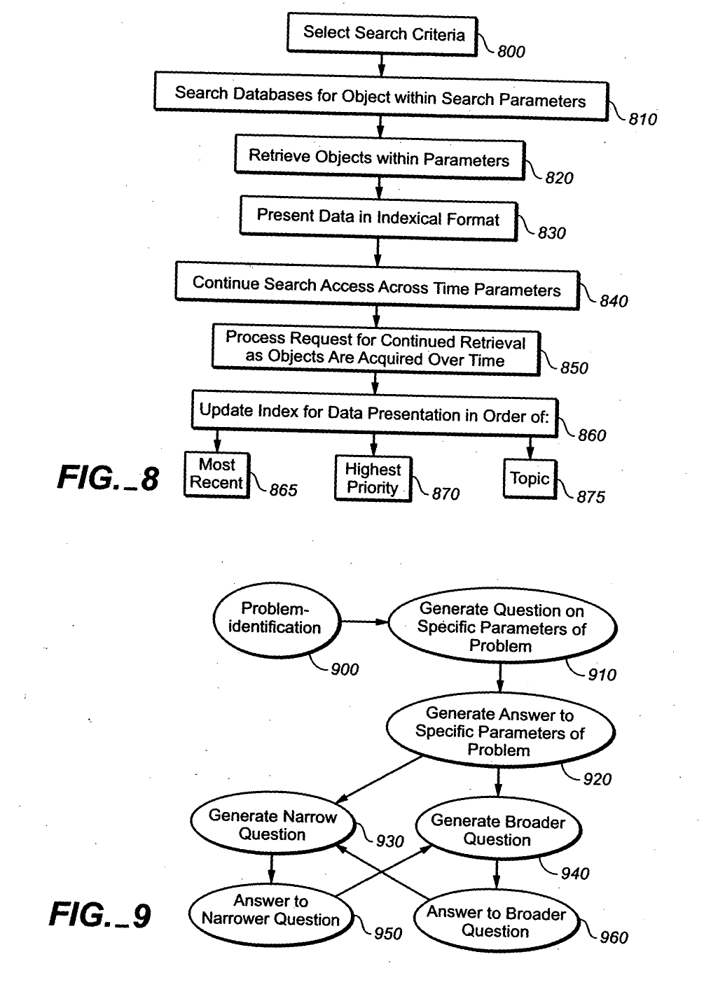

There are times when an individual requires information that is beyond an immediate search request. In these cases, an individual requires an “open” search request or a standing order for information over a specific time period. This type of search accommodates changes in the world which will eventually produce results, but which may not be immediately discernable. FIG. 8 shows the open search process.

The individual initially selects a search criterion (800) and searches databases with a query for an object within specific search parameters (810). The database retrieves objects within the search parameters (820) and presents the data in an indexical format (830). The search process continues to access the database across specified time parameters (840). The request for the continual retrieval of objects occurs over a specified time period (850). As new data objects are obtained, they are added to the index and the index is updated for presentation (860) in the order of most recent (865), highest priority (870) or topicality (875).

FIG. 9 is a flow chart describing a question generation process. After the initial identification of a problem (900), a question is generated on the specific parameters of the problem (910). An answer is generated in response to the specific problem parameters (920), after which, the question is either narrowed (930) or broadened (940). If the question is narrowed, an answer is provided to the narrower question (950); if the question is broadened, an answer is provided to the broader question (960). After this round of answers, the questions can be further broadened or narrowed as needed and further answers presented.

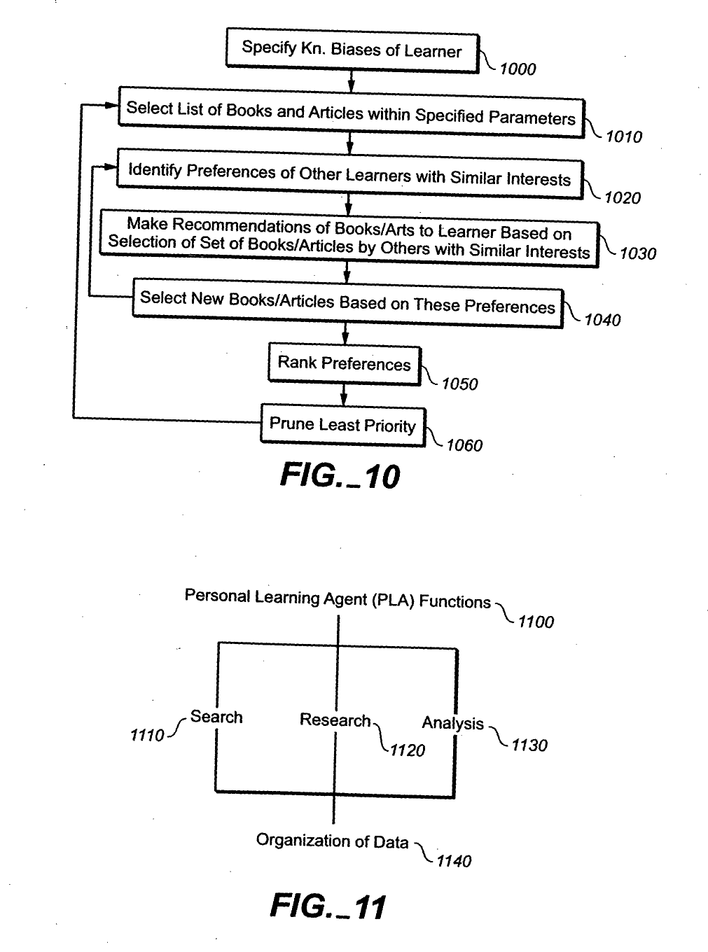

A collaborative filtering process provides an opportunity to broaden one's awareness of a subject by requesting recommendations from others with similar interests. FIG. 10 shows collaborative filtering for knowledge acquisition. After the knowledge biases of the learner are specified (1000) and a specified list of books and articles is created within the specified parameters (1010), preferences of other learners with similar interests (1020) are identified. Recommendations of books and articles are made to the learner based on the set of books and articles selected by others with similar interests (1030). This is achieved via the pooling and merging of various lists of books and articles of a group of individuals with similar topical interests. The titles or authors of books and articles that are common to most lists are listed in order of the highest ranking. The individual can then select new books and articles based on these preferences (1040) and thus expand their knowledge base. The process may continue by identifying the preferences of others in related topics (1020), or the individual may simply rank the results (1050) by reviewing the sum of the common list of preferences. After pruning the least important books or articles from the list (1060), the individual may continue the process by selecting a new list of books and articles from which to seek more references. The collaborative filtering process may be organized within a specific range of books identified by numerical indices within the Dewey decimal system. Other data categories, such as authors, are of possible use in this system.

The personal learning agent (PLA) is an intelligent mobile software agent that operates like an automated personal secretary. PLAs have several main functions specified in FIGS. 11 through 15. In FIG. 11, the PLA function categories are specified as search (1110), research (1120), analysis (1130) and organization of data (1140).

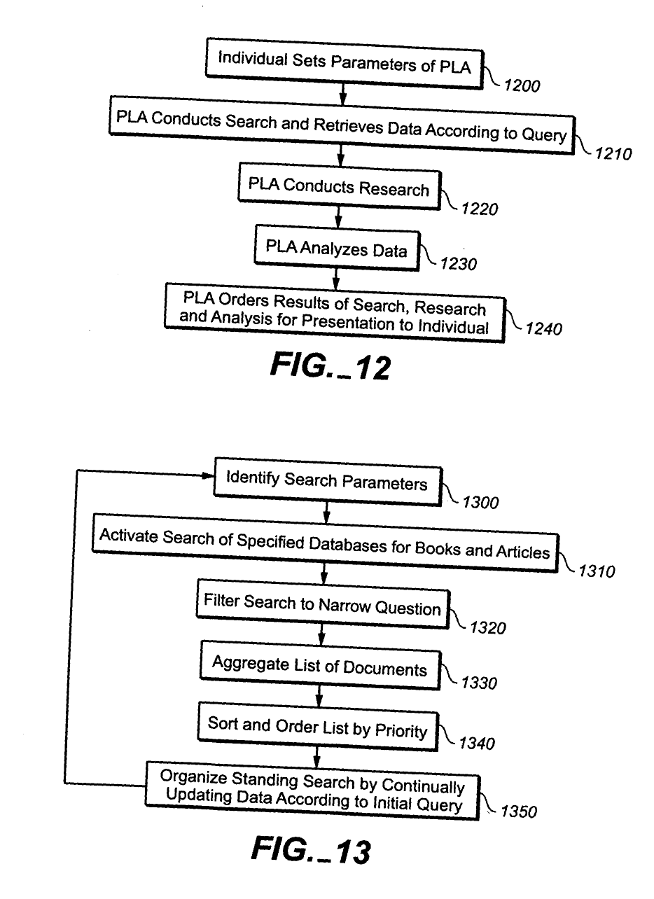

In FIG. 12, the individual sets initial parameters for the PLA (1200), and the PLA conducts a search and retrieves data according to a query (1210). The PLA then conducts research (1220) on a subject, analyzes the data (1230) and orders the results of the search, the research and analytic processes for presentation to the individual (1240).

In FIG. 13, after the initial search parameters are identified (1300), a search is activated by accessing specified databases for books and articles (1310). The search is filtered to narrow the question (1320), and an aggregate list of documents is created (1330). The list is sorted and ordered by priority (1340) with the least relevant sources pruned out and the most relevant sources given higher priority. A standing search is implemented by continuing this process and continually updating the data according to the initial query (1350). There are several reasons that a standing search is important. First, the data that is accessed is in continual transition and requires more than a snapshot of time to access. Second, the user requires more robust information than can be obtained from a single response to a single query. Third, the user needs to peruse multiple aspects of a problem which is best performed over time. Since true knowledge is seldom obtained immediately but rather occurs over the course of time, a standing search is a useful method of obtaining a deeper sense of information gathering.

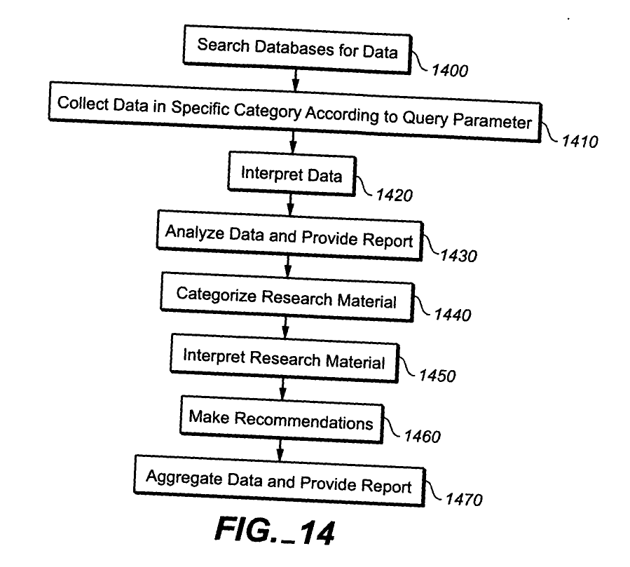

FIG. 14 shows the PLA research process. After databases are searched (1400) data is collected in a specific category according to the query parameter (1410). The data is interpreted (1420), analyzed, and a report of the results is provided (1430). The research material is then categorized by topic (1440), interpreted (1450), and recommendations are made (1460). The data is then aggregated and organized, and a final report is provided (1470).

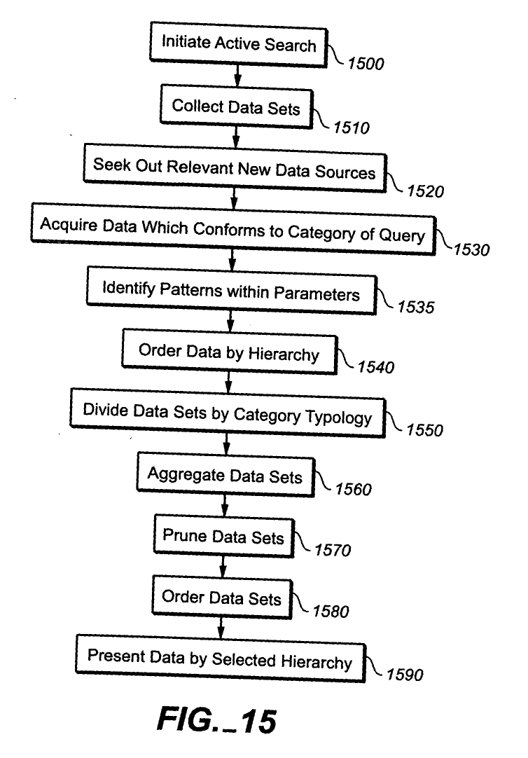

FIG. 15 shows the PLA analysis process. After the initial search is activated (1500) and data sets collected (1510), new relevant data sources are sought out (1520). Data is acquired from the search query (1530), patterns are identified within the search parameters (1535), and the retrieved data are ordered by hierarchy (1540). The data sets are then divided and organized by category (1550), aggregated (1560), pruned (1570) for unwanted or irrelevant information, and ordered (1580) for presentation by selected hierarchy (1590). Compare FIGS. 29 to 32 for a list of analytical methods that a PLA may employ.

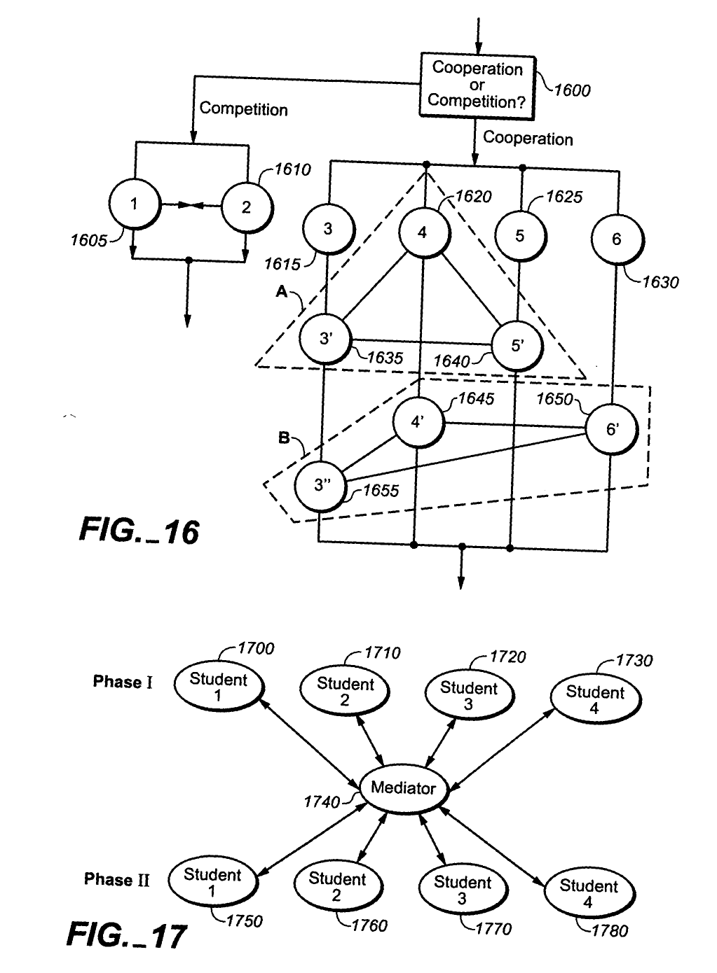

Collaboration between individuals is an important means of gaining knowledge. In setting up mechanisms of collaboration in a distributed interactive system, the approaches to collaboration can be either cooperative or competitive. Both competitive and cooperative collaborations have advantages and disadvantages. Competitive collaboration allows for an acceleration of the rate of learning, while cooperative collaboration allows for increased community interaction. There are also hybrid types of collaboration which combine elements of both cooperation and competition. In such cases, teams of cooperating individuals may compete with other cooperating teams. In a very real sense, businesses use this model in the economic system. FIG. 16 describes a model of competing and cooperating students in a distributed interactive system over time.

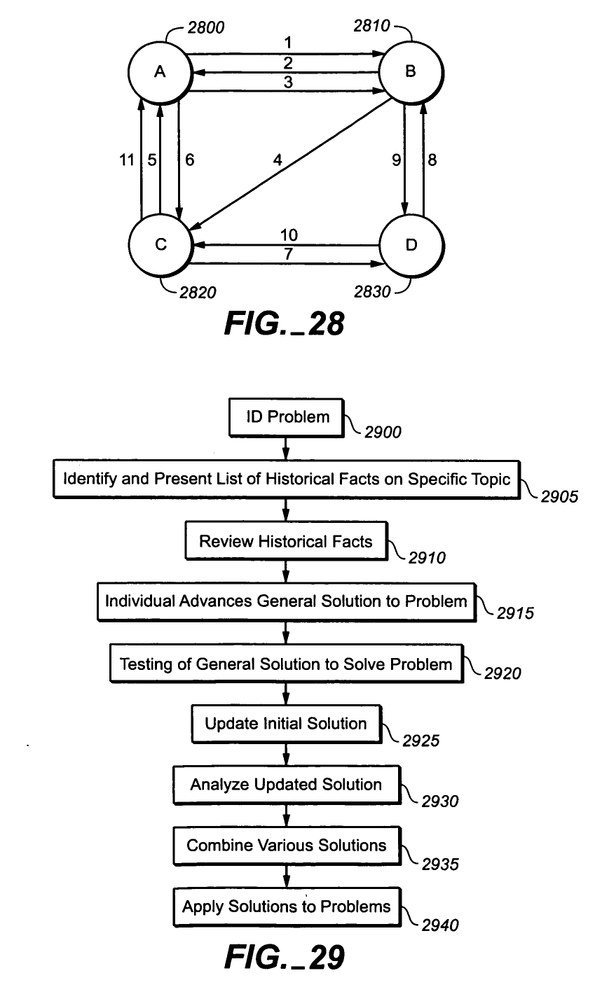

At the initial juncture of FIG. 16 the question is asked whether the individuals are competitive or cooperative (1600). If they are competitive, then students 1 (1605) and 2 (1610) will compete with each other at 1605 and 1610. In this example, the competition resembles an argument or a negotiation with each individual advancing a point and the other responding. Compare this model to FIGS. 27 and 28.

If they are cooperative, as in the case of students 3 (1615), 4 (1620), 5 (1625) and 6 (1630), then at points across time, they will cooperate on a specific topic. In this case, students 3 (1635) and 5 (1640) cooperate at a later time with student 4 (1620). However, student 5 eventually falls away, and students 3 (1655), 4 (1645) and 6 (1650) work together on a project with different parameters.

In an additional embodiment, students may, in order to extend their presence with multiple group projects, use IMSAs that act as their proxies in order to cooperate during development of specific projects. In this case, the IMSAs are programmed to interact with other students and other IMSAs in order to develop common interest projects. After a specified period of time, the IMSAs then collect the data from the outcome of the various projects and report back to the specific student who launched them. In this way, multiple simultaneous projects may be developed with periodic review and redirection of the IMSAs. This system allows students to far extend their range of projects beyond what they may do alone. For instance, it may now be possible for a student to meet with forty groups on forty topics in an afternoon. IMSAs easily perform the process of interacting with others in a common interest forum and collating the results for a student. In effect, the IMSAs are performing analogous functions to the errands of the student going to multiple classes.

FIG. 17 shows a multi-phasal process of student interaction in a distributed system. At the first phase, students 1 (1700), 2 (1710), 3 (1720) and 4 (1730) interact with a mediator (1740). In a second phase, the interaction continues among the mediator and the students.

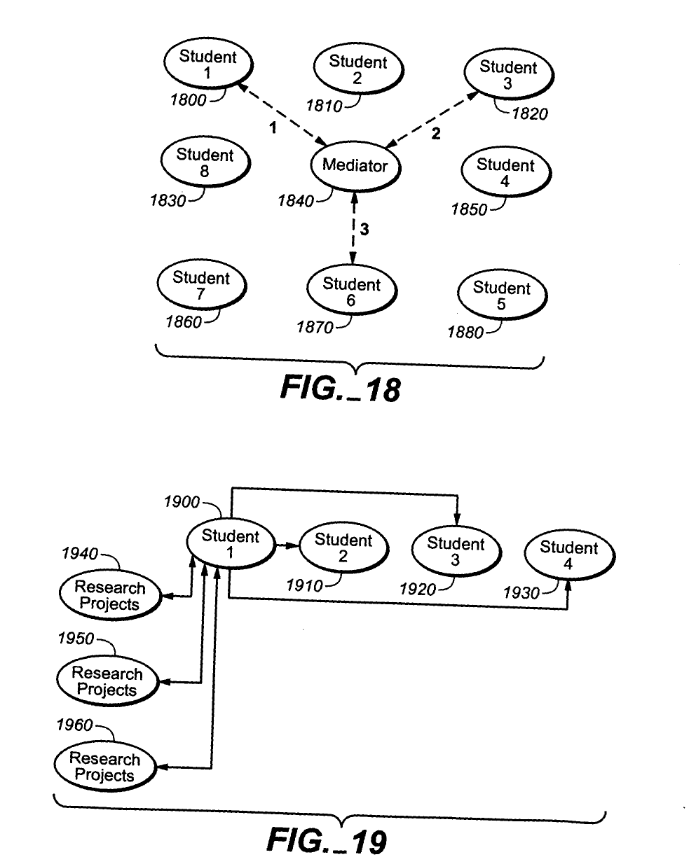

FIG. 18 shows the asymmetric interaction between students in a mediator-driven learning system. In this case, student 1 (1800), 3 (1820) and 6 (1870) interact with the mediator in an ordered sequence while the other students look on. This exchange allows students with information to be active.

In FIG. 19, there is no mediator to moderate the meetings of students. In this case, student 1 (1900) analyzes research projects (1940), (1950) and (1960) and interacts directly with students 2 (1910), 3 (1920) and 4 (1930). Under these circumstances, student 1 is a thought leader who acts as a student in the function of collecting information and as a teacher in the function of disseminating the information.

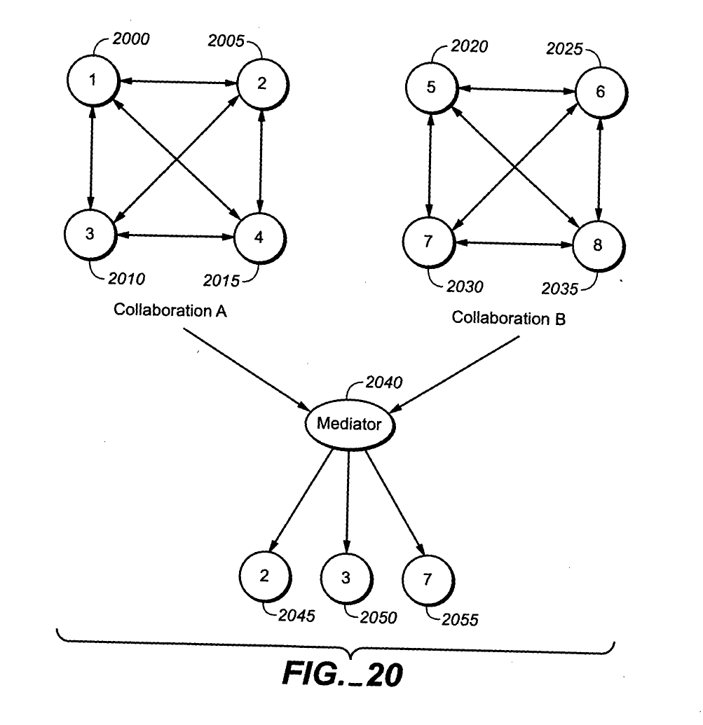

FIG. 20 shows two sets of students collaborating and interacting with a mediator. Students 1 (2000), 2 (2005), 3 (2010) and 4 (2015) interact in group A, while students 5 (2020), 6 (2025), 7 (2030) and 8 (2035) interact in group B. These two sets of collaborating students interact with the mediator (2040). The mediator chooses to interact with a specific subset of students from these groups. In this case, the mediator interacts with students 2 (2045), 3 (2050) and 7 (2055).

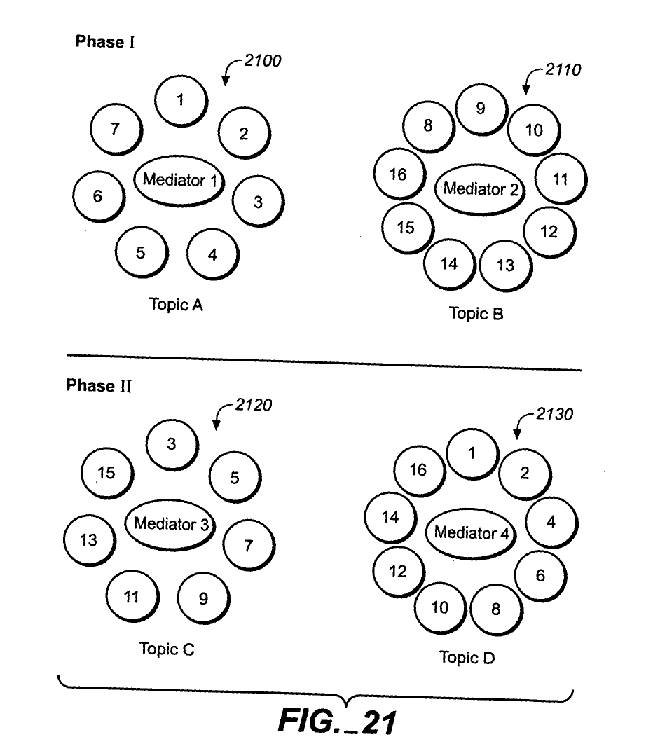

FIG. 21 is a multi-phasal diagram showing the process of students aggregating by common interest into new groups. In the first phase, the groups are initially organized by topic, with seven students and mediator 1 organized to pursue Topic A (2040) and with nine students and mediator 2 organized to pursue Topic B (2110). In the second phase, however, we see that the students have moved around to organize into new sets of groups for pursuing Topics C (2120) and D (2130).

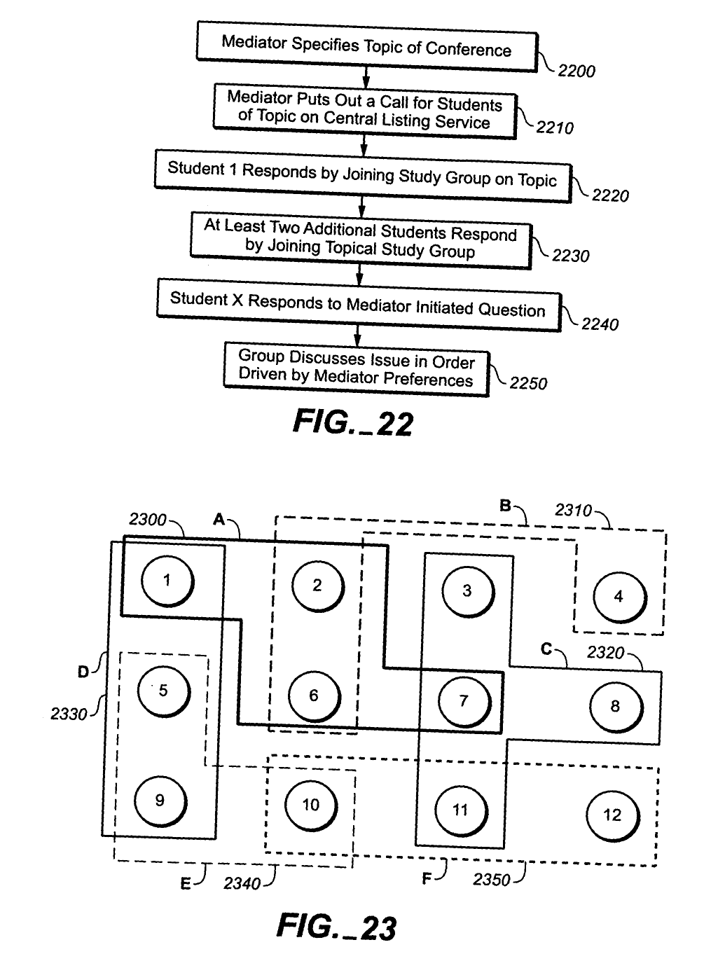

FIG. 22 is a flow chart showing a centralized mediator-driven distributed interactive class. After a mediator specifies a topic of a conference (2200) the mediator puts out a call for students interested in the topic on a central listing service (2210). Student 1 responds by joining the study group (2220). At least two additional students respond by joining the topical study group (2230). A student in the group responds to the mediator-initiated question (2240). The group then discusses the issue in the order controlled by the mediator's preferences (2250).

Eventually, students can break free of teachers and work together to gain substantive knowledge. In FIG. 23, different sets of students self-select for specific topics and self-organize into common-interest classes. The set A (2300) consists of students 1, 2, 6 and 7. The set B (2310) consists of students 2, 4 and 6. The set C (2320) consists of students 3, 7, 8 and 11. The set D (2330) consists of students 1, 5 and 9. The set E (2340) consists of students 5, 9 and 10. The set F (2350) consists of students 10, 11 and 12. Since there are overlapping sets of students, the groupings are asymmetric and generally represent different topical groups that meet at different times that can be logistically coordinated by the students.

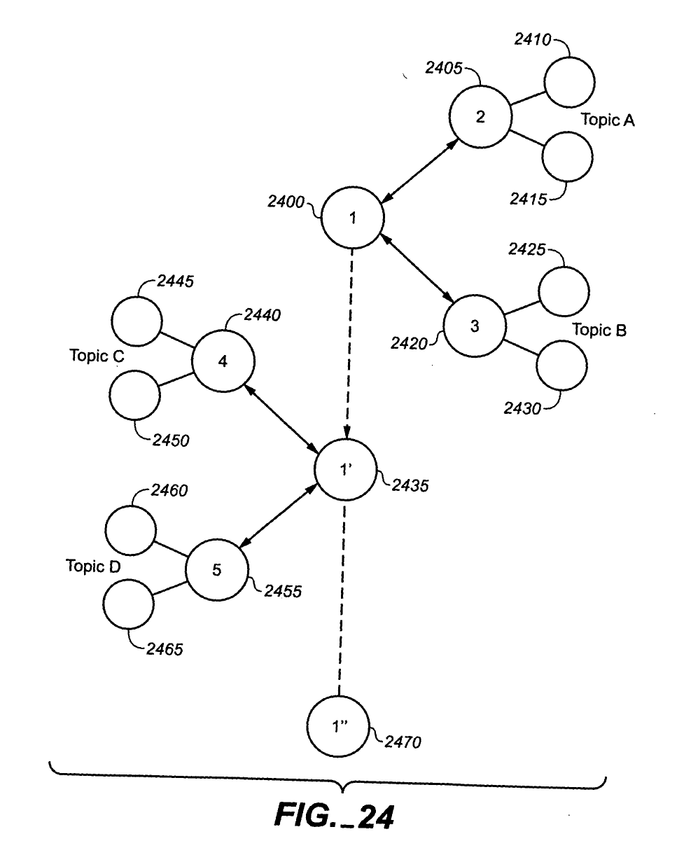

FIG. 24 shows a multi-phasal process of interacting students. Student 1 (2400) interacts with student 2 (2405) (who communicates with other students (2410 and 2415)) about topic A and with student 3 (2420) (who communicates with other students (2425 and 2430)) about topic B. At a later phase, student 1, at 2435, interacts with student 4 (2440) (who communicates with other students (2445 and 2450)) about topic C and student 5 (2455) (who communicates with other students (2460 and 2465)) about topic D. Student 1 later processes the exchanges (2470).

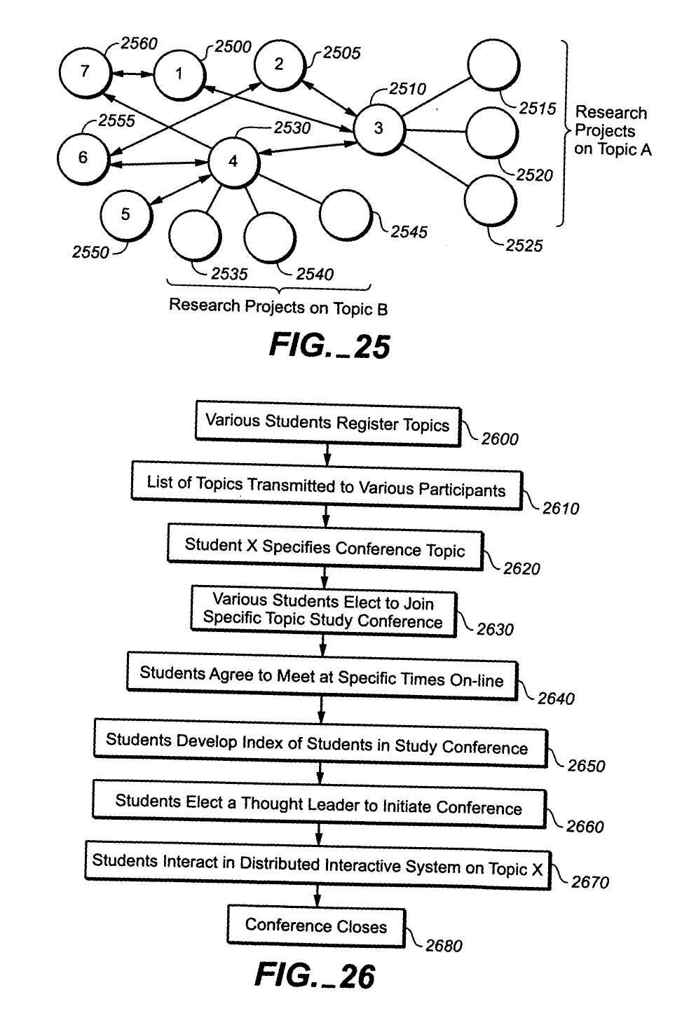

FIG. 25 shows a distributed interactive learning system in which various students collaborate on different research projects. Student 3 (2510) is the thought leader for research projects on topic A (2515, 2520 and 2525), while student 4 (2530) is the thought leader for research projects on topic B (2535, 2540 and 2545). Students 3 and 4 collaborate on various overlapping topics. Student 3 also interacts with students 1 (2500) and 2 (2505) on the research projects involving topic A. Student 4 interacts with students 5 (2550) and 6 (2555) on research projects involving topic B. In addition, student 2 (2505) communicates with student 6 (2555) and student 1 communicates with student 7 (2560) on various topics.

The disintermediation of student interactions allows the learning process to proceed without a mediator or teacher. FIG. 26 shows this process. In FIG. 26, various students register topics (2600) and the list of topics is transmitted to various participants (2610). Any particular student specifies a conference topic (2620), and various students elect to join a specific topic study conference (2630). Students agree to meet at specific times on-line (2640) to discuss the topic. The students develop an index of students in the study conference (2650) and elect a thought leader to initiate the conference (2660). Students then interact in the distributed interactive system on a specific topic (2670). After the conference is completed, the conference closes (2680).

Dialectical methods are of great value in the obtaining of knowledge. Typically, dialectical methods use a multi-phasal process in which a thesis is advanced and criticized. An alternative thesis is then advanced and criticized. In the final stage, a compromise position, or synthesis, is reached. The initial thesis may be the product of an inductive method, and the second thesis a product of a deductive method. Since each approach has strengths and weaknesses, a hybrid approach may be created to solve a problem. In the present invention, dialectical methods are employed to foster the processes of an individual-centered interactive learning system. FIGS. 27 to 34 describe various features of the dialectical process.

In FIG. 27, two individuals enter a multi-phasal process of argumentation. In Phase A, individual 1 (2700) presents an Argument A on Topic 1 to individual 2 (2705). In Phase B, individual 2 (2715) responds with Argument B on Topic 1 to individual 1 (2710). In Phase C, individual 1 (2720) responds with Argument C on Topic 1 to individual 2 (2725). This process resembles a debate. The topic then changes as individual 1 (2730) presents an Argument A on Topic 2 to individual 2 (2735). Individual 2 (2745) responds with Argument B on Topic 2 to individual 1 (2740). Finally, in this example, individual 1 (2750) responds to individual 2 (2755) with Argument C on Topic 2. The argumentation may continue until either one party wins the argument or there is a stalemate.

FIG. 28 shows a multilateral asymmetric argumentation process among four parties. In this example, A (2800) presents an Argument 1 to B (2810) and then B responds by presenting Argument 2 to A. After A responds with Argument 3 to B, B presents Argument 4 to C (2820). C then presents Argument 5 to A and A responds to C with Argument 6. C presents Argument 7 to D (2830) and D then presents Argument 8 to B. B responds with Argument 9 to D and D presents Argument 10 to C. Finally, C presents Argument 11 to A.

FIG. 29 shows a problem solving process. After a problem is identified (2900), a list of historical facts on a specific topic is generated and presented (2905). The historical facts are reviewed (2910) and an individual advances a general solution to the problem (2915). The general solution to the problem is tested (2920), and the initial solution is updated (2925) and analyzed (2930). Various solutions are combined (2935), and the solutions are applied to problems (2940).

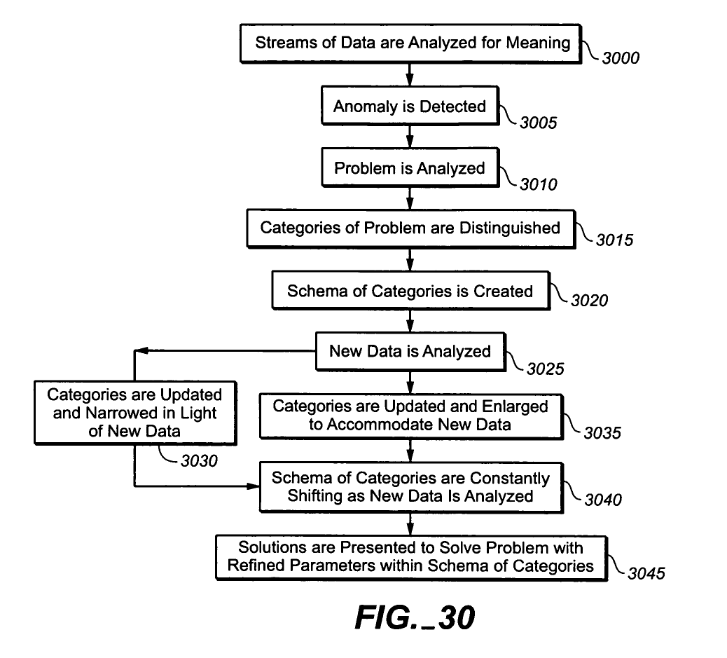

FIG. 30 shows a category schema process. After a first analysis of streams of data for meaning (3000), an anomaly is detected (3005) and a problem is analyzed (3010). Categories of the problem are distinguished (3015), and a schema of categories is created (3020). New data are analyzed (3025). At this stage, categories are either updated and narrowed in light of new data (3030) or enlarged to accommodate new data (3035). The schema of categories constantly shifts as new data are analyzed (3040). Solutions are presented to solve the problem with refined parameters within the schema of categories (3040). Category schemas are important to the dialectical process because they establish typologies of categories which, as they evolve, present better ways of understanding.

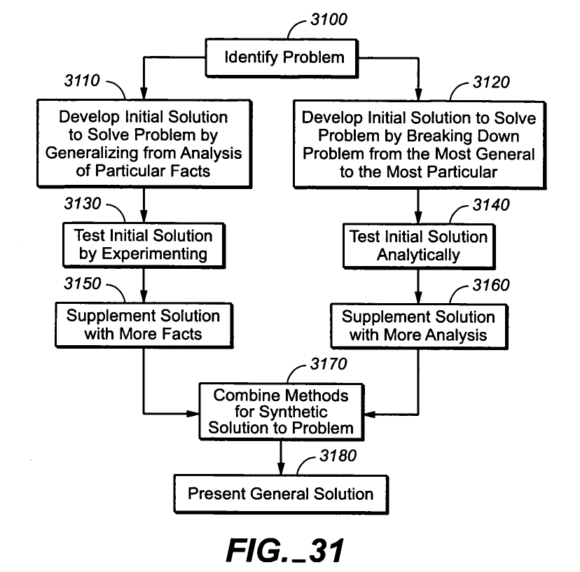

The individual-centered education system embraces multiple methods of analysis. One chief analytical method involves problem-centered learning. The solving of problems advances knowledge. Two main types of problem solving are to found in the inductive and deductive methodologies. FIG. 31 shows a model for problem solving using these two main methods.

After a problem is identified (3100), an initial solution is developed by generalizing from an analysis of the particular facts (3110). The initial solution is tested by experimentation (3130) and supplemented with more facts (3150). Alternatively, another solution is developed by breaking down the problem from the most general to the most particular facts (3120), testing the initial solution analytically (3140) and supplementing this solution with additional analysis (3160). Both methodologies combine to produce a synthetic solution to the problem (3170), which provides a more complete solution than either method can produce alone, and the general solution is presented (3180).

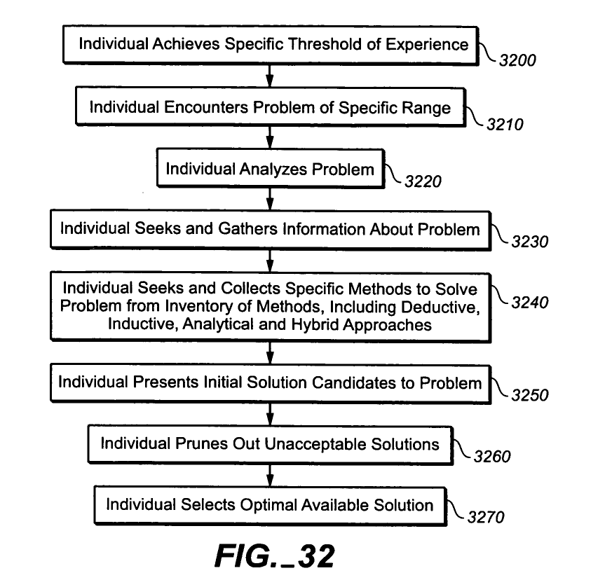

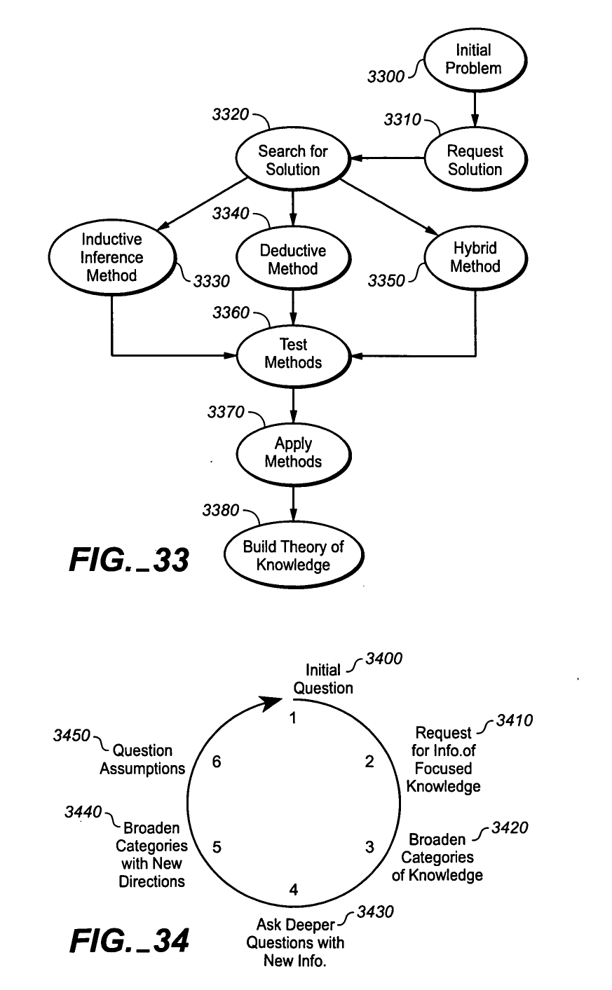

Another major learning method that may be implemented in an individual-centered customized learning system is based on the Bayesian reasoning model. This method is illustrated in FIG. 32. After an individual achieves a specific threshold of experience (3200), the individual encounters a problem of a specific range (3210), analyzes the problem (3220) and seeks and gathers information about the problem (3230). The individual then collects specific methods to use to solve the problem from among an inventory of methods, including deductive, inductive, analytical and hybrid approaches (3240). The individual presents initial solution candidates to solve the problem (3250), prunes out unacceptable solutions (3260) and selects the optimal available solution (3270). Because the use of expertise has become increasingly important to our post-industrial economy, the use of the Bayesian reasoning approach, which values the combination of experience with the analysis of new information for the purpose solving complex and novel problems, has become valuable. More and more, the ability to master expertise, as with the Bayesian reasoning process, has depended upon the identifying and selecting of appropriate methods to solve a problem at the right time. FIG. 33 shows the application of various methods to problem-solving at key times.

In FIG. 33, an initial problem (3300) is presented, and a solution is requested (3310). A search for a solution (3320) to the problem commences. Three problem-solving methods are presented: the inductive inference method (3330), the deductive method (3340) and a hybrid method (3350) consisting of a combination of methods. The methods are tested (3360) and applied (3370) to the problem. This process results in the development of research programs that contribute to the building of a theory of knowledge (3380) that is useful to further problem solving processes and to learning in general.

The dialectical process uses these various problem solving techniques in an integrated system. From the applying of knowledge categories and analytical and synthetic methods, knowledge evolves. A circle of knowledge is represented in FIG. 34. After an initial question is formed (3400), a request for information is made of focused knowledge (3410); the categories of knowledge are broadened; (3420) and deeper questions are asked based on new information (3430). In order to answer the new questions, the categories of knowledge are broadened within new parameters (3440), and the assumptions to the questions are challenged (3450). The question is re-examined in the light of the new information and the initial examination process repeats and the circle continues until substantial knowledge is obtained.

Individuals have different learning styles. These learning styles are classified mainly according to cognitive differences. For example, individuals with a bias towards the right hemisphere of the brain, which controls non-linear ways of processing data, may be more creative learners than left hemisphere dominant individuals. Consequently, an individual-centered customized learning system must develop learning techniques that correspond to each respective learning type. Though each individual can make use of various learning methods, some methods may be more expedient for them because of physiological advantages, and thus specific methods may become more preferred. In point of fact, it may be the less dominant methods that individuals will need to develop in order to complement their natural strengths. FIG. 35 is a flow chart of a typology of learning profiles. Various cognitive differences among individuals are identified (3500), and a typology of learning types is developed (3520) as in FIG. 4. Learning approaches are developed and tailored to each learning type (3540).

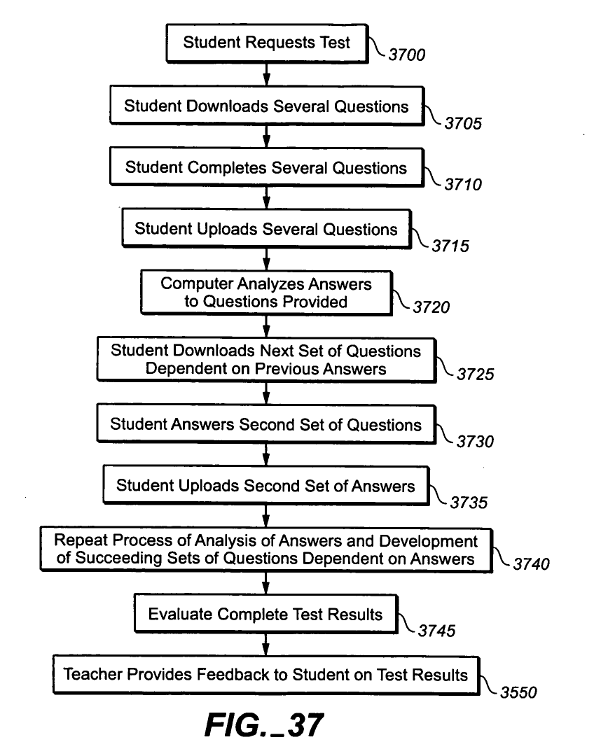

The customized assessment of an individual's knowledge about a topic in an interactive distributed computer system is made possible by the present invention. FIG. 36 describes a time-sensitive testing process. After a student completes a course (3600), the student requests a test on a specific topic at a specific level (3610). The student downloads a test (3620) on the subject and completes the test (3630). After completing tests at a specific level of achievement, the student becomes certified in an area (3640). The use of interactive technology allows this process to be time sensitive. This idea is pushed further in FIG. 37 which describes a customized dynamic testing process in real time. Overall, this system presents a model for just-in-time teaching and evaluation which is intended to accelerate the learning process.

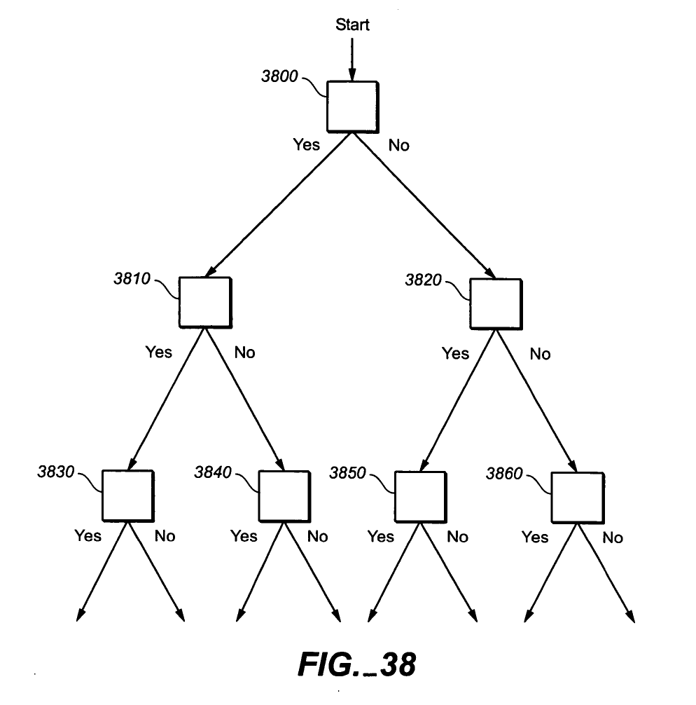

In FIG. 37, after the student requests a test (3700), the student downloads (3705), completes (3710) and uploads (3715) several questions. A computer analyzes the answers to the questions provided (3720) and presents another set of questions contingent upon the answers to the first set downloaded by the student (3725). The student answers the second set of questions (3730), and the student uploads the second set of answers (3735) to be evaluated by the computer. The process of analyzing the answers and developing succeeding sets of questions dependent on the previous answers is repeated (3740) until the complete test results are evaluated (3745). The teacher provides feedback to the student on the test results (3550). This process is intended to emulate a dynamic expert system which continues to hone expertise until knowledge is obtained. The combining of interactive technologies in the present invention develops a dynamic testing process. The dynamic testing system is further described in FIG. 38, in which, after each question is answered, a new question is generated contingent on the previous response.

In this tree diagram, FIG. 38 shows a question (3800) that is answered. If the answer is “yes”, the next question (3810) is proposed. If the answer is “no”, another question (3820) is offered. If the student answers the question (3810) resulting from the first affirmative response with a “yes”, then the student is presented with a new question (3830), while if the student answers the question (3810) with a “no”, then the student is presented with yet another question (3840). Similarly, if the student answers “yes” to the second question (3820) which derived from a negative response to the initial question, he or she is presented with a specific question (3850), whereas, if the student answered negatively again to the second question, he or she receives still another question (3860). This customized learning process allows a teacher to isolate lines of reasoning in a more focused way and to detect very specific knowledge acquisition by a student.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

1. A customized demand-initiated e-learning system architecture having a plurality of system layers interconnected to one another, comprising:
A first layer including a hardware and software system including microprocessors and pushed databases for just-in-time (JIT) teaching;
A second layer including problem finding and question generation;
A third layer including personal learning agents (PLAs);
A fourth layer including collaboration using intelligent mobile software agents (IMSAs);
A fifth layer including distributed interactive classes with mediation;
A sixth layer including distributed interactive classes without mediation;
A seventh layer including dialectical learning processes for problem solving in a distributed interactive system;
An eighth layer including a mechanism for the assessment of individual abilities.
